(19) United States
(12) Patent Application Publication
(10) Pub. No.: US 2006/0102597 A1
(43) Pub. Date: May 18, 2006

(54) Electron beam welding method and apparatus using controlled volumetric heating

(75) Inventors: Stuart Brown, Needham, MA (US); Jason Clevenger, Watertown, MA (US); Patricio Mendez, Lakewood, CO (US)

Correspondence Address: BERENATO, WHITE & STAVISH, LLC, 6550 ROCK SPRING DRIVE, SUITE 240, BETHESDA, MD, 20817, US

(73) Assignee: Exponent, Inc.

(21) Appl. No.: 10/988,999

(22) Filed: Nov. 16, 2004

(51) Int. Cl. B23K 15/00

(52) U.S. Cl. 219/121.14; 219/121.13

(57) ABSTRACT

Electron beam welding of a thin layer to a substrate is accomplished using controlled volumetric heating of the respective substrate layers, thus minimizing gradients due to heat conduction. Electron beam penetration of the layers and velocity across the surface creates a rapidly translating weld pool within the substrates. The control parameters for the electron beam source are dependent on the heat characteristics of the substrate materials, their thickness, available electron beam power and speed, and desired finished weld geometry. The Peclet number maintained during the process is greater than about 1 and less than about 10.

### FIELD OF THE INVENTION

The present invention is related to a method and apparatus using an electron beam to weld a thin material to a substrate. One such example is joining a sealed cover to a substrate containing microelectronic or microelectromechanical (MEMS) components. More specifically, the present invention is directed to a method of electron beam welding using a controlled electron beam source to achieve volumetric heating of the materials being welded, taking into account the heat characteristics of the materials involved, the operating parameters of the electron beam source, and the nature of the finished welded product desired.

### BACKGROUND OF THE INVENTION

High energy density sources such as electron beams and lasers have been used in the past in order to successfully join materials at a macroscopic level. The way in which these methods operate to join materials at a macroscopic level are known to contain a variety of drawbacks that prevent their successful use with respect to microscopic dimensions. Although many current electron beam welding machines have proven sufficient to join materials in macroscopic applications, their power densities, large spot sizes and traveling speeds typically cause a characteristic shape of the molten region known as a keyhole, which is undesirable for microscopic applications. A keyhole is a phenomenon in which a high intensity heat source creates a narrow and deep hole in the welded parts and substantial evaporation directly under the heat source. Subjecting microelectronic structures to such processing would result in the destruction or significant damage to the structure itself, thereby rendering it unusable. Such techniques introduce difficulties associated with capillary forces, fluid flow, heat transfer, and evaporation dynamics of the keyhole and produce significant thermal stresses and distortion into the package.

Known laser beam welding systems have exhibited additional drawbacks that prevent them from being effectively used to seal packages containing microelectronics and MEMS systems. In laser beam welding there are significant losses and hazards associated with the reflection of the beam. The control of heat penetration with a laser beam is coupled to the beam intensity; therefore, it is more difficult to achieve than with an electron beam. Likewise, some materials are more opaque or transparent to light causing either ablation or excessive penetration of the laser beam. In addition, a variety of materials cannot be laser welded including glasses, silicon, silicon nitrides, silicon carbides, diamond and metals less than 100 microns in thickness.

Other methods have been used to join electrically conductive or non-conductive materials such as ceramics or glass in the past; however, they are not particularly useful in attempting to join thin materials at the microscopic level without unduly damaging or stressing the materials in the process. These techniques include metal solders (which are conductive and therefore may cause problems with signal loss in electrical applications and also require elevated temperatures), glass frits (glass powder in a carrier that is deposited and subsequently melted in a furnace) and polymer adhesives such as epoxies which produce contaminants. Similarly, although prior art techniques for hermetic packaging of MEMS devices exist that use some of these methods, they require slow and expensive multi-stage techniques which involve deposition of a joining compound and subsequent heating. Several examples of these known methods are described below. All of the methods describing electron beam welding rely upon heat conduction through the materials with the inherent drawbacks that result therefrom described above.

In U.S. Pat. No. 6,573,471, electron beam welding is used to join the ends or sides of semiconductor wafers made from silicon, gallium, or arsenic. This patent declares that electron beam welding of such materials was thought to be “impossible” owing to their inherently brittle nature and destruction when high thermal gradients are present. As such, this method achieves welding by a slow and extended process of ramping the heat from a high energy heat source into the materials to be joined in a very controlled manner to reduce heat shock to the materials being joined and the consequent results. In one preferred embodiment, this method describes a multi-stage process that involves first pre-heating the substrate to about 600° C., and thereafter performing the electron beam welding. In another embodiment a filler material is required used between the joined materials. The disclosed welding method relies on diffusion of the heat from an initial point of exposure to the electron beam into the substrate.

U.S. Pat. No. 5,517,059 describes an electron beam welding apparatus for welding semiconductor terminals in an industrial setting using either an electron beam or laser as a source of collimated energy to perform the welding. This process is intended to replace conventional soldering of the terminals and attempts to lessen the possibility of semiconductors being damaged by welding flash using conventional methods. This reference does not disclose any details on how to accomplish electron beam or laser welding aside from stating that these processes are the source of welding heat.

U.S. Pat. No. 4,506,108 discloses a multi-component encapsulation structure for microcircuits. The disclosed structure is in part sealed using either an electron beam or laser weld. The disclosed welding process is performed on metal. Semiconductor materials such as Si are not disclosed as being welded by this process.

U.S. Pat. Nos. 5,786,548, 6,368,899 and US published applications 2002/0179986, 2003/0230798 and 2003/0170966 also discuss the desirability of encapsulating MEMS using various multi-stage techniques. None of these references discusses the use of an electron beam to achieve the encapsulation.

U.S. Pat. No. 4,382,186 is directed to a method of controlling an electron beam shaped as a line as opposed to a spot. The line shape is intended to use the electron beam for annealing, welding and cutting. This reference states that the fundamental disadvantage of a point source electron beam is the thermal diffusion from the point source requiring higher absorbed flux to reach a given temperature. This patent further concludes electron beams are not well suited to volume heating due to excessive damages to the surface of the treated substrate.

Electron beam sources also have other known uses such as inspection by electron microscopy. In the described prior art uses of electron beam technology, the electron beam spot source is typically either too strong (such as those using ramping of heat or that develop an electron beam line) or too weak (electron microscopy) for the currently proposed method of volumetric heating to achieve welding of thin substrates. While current electron beam welding machines have sufficient accelerating voltage and can provide more than adequate power (typically mA), the spot size is typically much too large (>100 μm) and the likely result is grooving or keyholing (through excessive material evaporation) of the underlying substrates. Electron microscopes, on the other hand, typically have sufficient electron acceleration and can be focused to a small enough spot size, but the maximum beam current is inadequate (typically nA) to achieve welding.

### SUMMARY OF THE INVENTION

The present invention uses controlled electron beam welding to join a thin layer to a substrate placed adjacent one another without requiring the use of fillers or time consuming ramping of energy levels. In this invention, the small size of the beam and the high speed of motion enable the rapid joining of electrically conductive or non-conductive materials such as ceramics or glasses on a microscopic level (less than 100 microns) using an electron beam. This method is especially relevant for the hermetic packaging of MEMS, which currently require slow and expensive multistage techniques. (see U.S. Pat. Nos. 5,786,548, and 6,368,899, as well as U.S. Published Patent Application Nos. 0170966 and 0230789, all referenced above.) In the present invention, an electron beam moves rapidly in a defined path around the edge of the cover, partially melting it and the substrate, thus creating a structural and airtight seal. The atmosphere sealed inside the cover might be a vacuum, partial vacuum, or a desired gas depending on the structure being encapsulated.

The present invention enables the fabrication of packaging with the use of a minimum amount of metal, or no metal at all. Metals or other conductors are known to cause significant losses in the performance of MEMS for RF (radio frequency) applications. In certain applications, small amounts of metal might be helpful to provide a conductive path for the electrons involved in the process. This metal would be deposited as a thin coating (thickness of the order of nanometers) over the non-conductive material. This thin coating can be removed easily with standard techniques, avoiding signal attenuation losses in the final product.

The proposed method of electron beam welding of a cover directly to a substrate provides advantages over the traditional techniques of fabrication that involve several intermediate steps (doping and coatings) and temporary structural components that must be built and removed in the process. The present invention is well suited for keeping a vacuum atmosphere, because an electron beam performs at its best in vacuum, although operation under partial vacuum and controlled atmosphere is also viable.

In the present invention, the electron beam is controlled using operating parameters such that the electron beam has enough power density and traveling speed so as to cause sufficient melting of the area under the beam to create welding, but without causing excessive evaporation or a keyhole. Owing to the uniquely calculated operating parameters for the electron beam used, the present invention does not experience the difficulties associated with the capillary forces, fluid flow, and evaporation dynamics of the keyholing, thus enabling the use of a small focus spot size. The small spot size of the present method also produces lower thermal stresses within the package, resulting in less thermally induced distortion in the finished product.

### BRIEF DESCRIPTION OF THE DRAWINGS

These and other aspects and objects of the invention will become better understood from the following detailed description of various embodiments thereof, when taken in conjunction with the drawings wherein:

FIG. 1 illustrates a typical use of the present method to seal a cover to a substrate.

FIG. 2 is a schematic of the present method showing the axis of beam movement, spot size, and penetration.

FIGS. 3A and 3B are partial cross sections of single or layered substrates being subject to the present method showing the melt pool created by the volumetric electron beam heating.

FIG. 4 is a spreadsheet showing typical input parameters (in dotted outline) for electron beam welding according to the present method and calculated Process Parameters for control of the electron beam source on the basis of a round gaussian heat source with exponential decay under the surface.

FIG. 5 are example process parameters for Silicon, Silicon Nitride, and Silica glass showing three different weld geometries of 1 micron, 10 microns, and 100 microns depth (in all these cases the depth of the weld approximates electron beam penetration occurring during the process).

FIG. 6 is a table showing the maximum and minimum values of the process parameters for the current method.

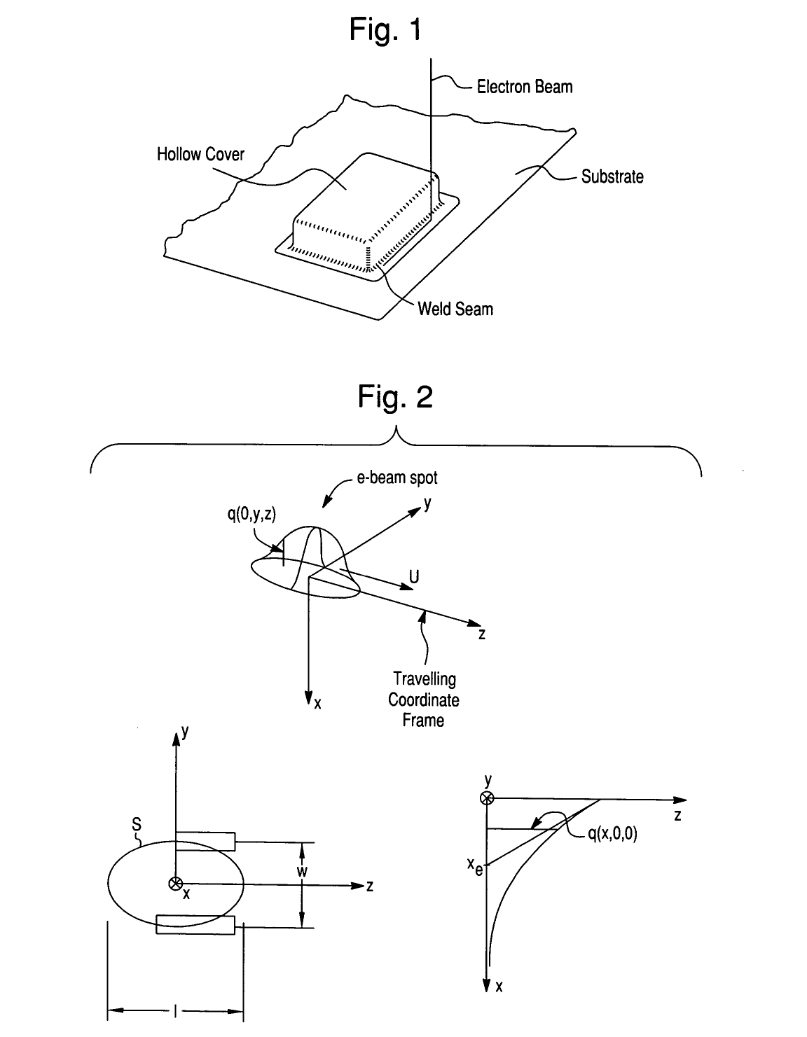

### DETAILED DESCRIPTION OF CERTAIN PREFERRED EMBODIMENTS OF THE INVENTION

The present invention will now be described in connection with a variety of examples. It should be understood by those of ordinary skill in the art that this disclosure and these examples are exemplary of the invention and intended not to be limiting or to exclude insubstantial variations of the inventions disclosed, which are intended to be part of the present invention.

The present invention is described in connection with the joining of a cover to a substrate containing microelectronic or MEMS components under vacuum or controlled environments. The invention is also related to the joining of electrically conductive or non-conductive materials, such as ceramics or glasses. Electron beam welding of microelectronic packaging in accordance with the present invention provides advantages over traditional techniques of fabrication, which involve several intermediate steps and temporary structural components that must be built and removed in the process.

The present invention depends upon volumetric heating rather than heating by conduction as has typically been employed in prior electron beam welding processes. Volumetric heating with heat penetration substantially on the order of the melting penetration is the key to avoiding ablation in the finished structure. Electrons from an electron beam naturally have a penetration on the order of a few microns, and this effect is also exploited through this method. Keyholing and ablation are substantially avoided and are expected to be effectively eliminated utilizing the parameters of the electron beam method of the order of magnitude described in detail to follow. As described above, keyholing and ablation are typically present and result from the standard form of operation of high intensity moving heat sources, such as electron beams or laser beams at the macroscopic (above 100 microns) level. The present invention avoids such problems by utilizing a low beam power that transfers only the amount of heat necessary to melt a depth of a few microns of the substrate at a speed fast enough to minimize heat losses due to conduction heat transfer. Such a process accomplishes, for example, the welding of a cover to a desired location on a substrate without significantly affecting the temperature or other portions of the substrate.

Two important aspects of the current method are beam velocity across the workpiece and beam penetration into the workpiece(s). Ideally the traveling velocity is high enough so that diffusion is not the primary heat transfer process. Rather, virtually instantaneous volumetric heating of the treated materials is sought; this modality of the current method avoids the problems of surface heating common in other types of electron beam welding processes that lead to the “plowed” field result or the destructive thermal shocks in the finished structure.

The relatively high electron beam traveling velocity necessary in the present method to avoid keyholing or excessive ablation requires controls with a very quick response time. As electron beam optics require no moving parts, they have much faster response times than mechanical mirrors used in laser beam welding applications. The extremely localized nature of the heat source also minimizes the effects of the manipulation and processing steps to other parts of the circuit (MEMS) being processed along with the substrates.

The penetration of the electron beam into the welding substrate is relied on to assure that the heat input into the substrate is primarily volumetric, as compared to commonly used electron beam techniques that rely on heating by conduction from a substrate surface being exposed to the electron beam. Volumetric heating enables the use of very high energy density without ablation, which is a very well known limitation of high intensity surface heat sources, such as laser and electron beams in macroscopic dimensions. Electron beam welding provides advantages over laser beam welding in which there are significant losses and hazards associated with the reflection of the beam. Also, at the microscopic sizes of interest, the electron beam offers much better control of beam penetration than laser welding due to the restrictions on material opacity to laser light. In electron beam welding, penetration can be controlled with the acceleration voltage.

For the present invention, various physical properties must be satisfied in balancing the method parameters of beam spot size, velocity over the workpiece, penetration into the workpiece, and power. What makes the realization of this balance possible for a given selection of materials to be joined is controlling the Peclet number, Pe, obtained during the process of welding. The Pe is a dimensionless quantity related to the traveling velocity of the welding beam, the size of the welding beam, and the thermal diffusivity of the particular material to be welded. The Peclet number is essentially a measure of the relative importance of heat transfer conducted through a material, versus heat transfer facilitated by the motion of the plate relative to the heat source. In the welding process described, Pe should be greater than about 1 and preferably greater than 1 and less than about 10.

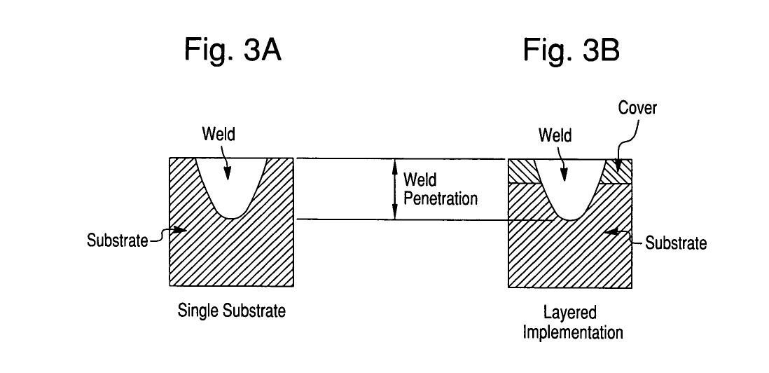

With reference to the traveling coordinate frame schematic shown in FIG. 2, the following calculations are relevant to the present method in ultimately determining the process parameters of beam diameter (w), voltage (V), current (I), and traveling speed (U) that are the object of the method. The weld pool achieved using the method is shown in FIGS. 3A (single layer) and 3B (multi-layer).

The calculations of the method begin with a determination of the Peclet number, in this method greater than 1, and working from that threshold to obtain the process parameters.

$$Pe = \frac{Ud}{α}$$

where

U=velocity of traveling e-beam

d=smallest of weld penetration (xₘ) or spot length (l)

α=heat diffusivity of substrate.

Volumetric heating, as opposed to diffusive heating from the surface, implies that the weld penetration (xₘ) is of the same order of magnitude of the penetration of electrons under the surface (xₑ), i.e. electron penetration sets the inward extent of the weld pool volume into the materials being welded.
xₘ≈xₑ

The goal of the method is to determine the beam parameters for the properties of the substrate and for a target weld width and penetration (weld geometry). The parameters determined by the present method are:
beam diameter (w)
beam voltage (V)
beam current (I)
beam velocity (U)

However, in order to derive these parameters, we need to calculate how these parameters are influenced by the materials being joined and their response to electron beam exposure.

The volumetric heat source q(x,y,z) has a characteristic length (l), a characteristic width (w) (l and w characterizing spot size (s) of the electron beam), and a characteristic penetration (xₑ). Normalizing the coordinates using these characteristic lengths yields.

$$\begin{matrix}x = {x}_{e} {x}^{*} \\ y = \frac{w}{2} {y}^{*} \\ z = \frac{l}{2} {z}^{*}\end{matrix}$$

As a result, a general expression of q (x,y,z) is:
q(x,y,z)=qₘₐₓq*(x*,y*,z*)
and, using a stationary coordinate frame:

$$\begin{matrix}z = - Ut \\ t = - \frac{z}{U} \\ = - \frac{l}{2 U} {z}^{*}\end{matrix}$$

For convenience we can define

$$t = \frac{l}{2 U} {t}^{*}$$

The temperature can be normalized as:
T(x,y,z)=T₀+TₘₐₓT*(x*,y*,z*)
Where:

T₀ is the initial temperature of the substrate (i.e., room temp)

Tₘₐₓ is the maximum temperature anywhere in the substrate

And where
ΔT(x,y,z)=T(x,y,z)−T₀
Heating rate for a point within or on the substrate:

Temperature increase=energy input
ρcₚ\dot{T}=q
This equation does not include conduction terms; this is because conduction is negligible at the high Peclet numbers of interest. This equation also neglects the solid-liquid phase change.
Where:

ρ=density

cₚ=heat capacity

T=temperature

q=volumetric heat input
Hence, using normalized functions:

$$\begin{matrix}ρ {c}_{p} {T}_{max} \frac{2 U}{l} \frac{ⅆ {T}^{*}}{ⅆ {t}^{*}} = {q}_{max} {q}^{*} \\ ρ {c}_{p} {T}_{max} \frac{2 U}{l} {\int }_{- ∞}^{∞} \frac{ⅆ {T}^{*}}{ⅆ {t}^{*}} ⅆ {t}^{*} = {q}_{max} {\int }_{- ∞}^{∞} {q}^{*} ⅆ {t}^{*} \\ ρ {c}_{p} {T}_{max} \frac{2 U}{l} {Tc}^{*} ( {x}^{*} , {y}^{*} ) = {q}_{max} {I}_{l} ( {x}^{*} , {y}^{*} )\end{matrix}$$

where Tc* (x*,y*) is the maximum temperature reached after the heat source moves over that point; and I₁(x*y*) is a dimensionless function that depends only on the shape of the volumetric heat source.

For T=Tₘₐₓ, T_{c}*=1, this happens at x*=0, y*=0, that is, the maximum temperature occurs on the surface, at the centerline.
Thus:

$$ρ {c}_{p} Δ {T}_{max} \frac{2 U}{l} = {q}_{max} {I}_{l} ( 0 , 0 )$$

Energy Balance in the Substrate

$${\int }_{v} q ⅆ v = W$$

$${\int }_{x = 0}^{∞} {\int }_{y = - ∞}^{+ ∞} {\int }_{z = - ∞}^{∞} q ⅆ x ⅆ y ⅆ z = W$$

Where

W=beam power: W=IV

I=beam current

V=acceleration voltage
Hence, using normalized functions:

$${q}_{max} {x}_{e} \frac{w}{2} \frac{l}{2} {\underbrace{{\int }_{0}^{∞} {\int }_{- ∞}^{∞} {\int }_{- ∞}^{∞} {q}^{*} ⅆ {x}^{*} ⅆ {y}^{*} ⅆ {z}^{*} = W}}_{{I}_{2}}$$

$$Thus \text{:}$$

$$\frac{1}{4} {q}_{max} {x}_{e} {wlI}_{2} = W$$

Weld Penetration and Width

The weld penetration is given by the deepest point melted under the beam, this occurs at the centerline y*=0. This point is xₘ*. This assumes that penetration does not increase after the beam passes a selected point.

Using the equation of thermal balance for

$${T}_{c}^{*} ( {x}_{m}^{*} , 0 ) = \frac{Δ {T}_{m}}{Δ {T}_{max}} ρ {c}_{p} Δ {T}_{m} \frac{U}{l} = {q}_{max} {I}_{l} ( {x}_{m}^{*} , 0 )$$

combining with the thermal balance for T_{c}*(0,0)

$${I}_{l} ( {x}_{m}^{*} , 0 ) = {I}_{l} ( 0 , 0 ) \frac{Δ {T}_{m}}{Δ {T}_{max}}$$

From this implicit equation we can obtain xₘ* from the melting temperature of the substrate and the maximum allowed temperature.

Similarly, the widest melted points occur on the surface, to the side of the centerline. These points are x*=0 y*=±yₘ*

Using the equation of thermal balance for

$${T}_{c}^{*} ( 0 , {y}_{m}^{*} ) = \frac{Δ {T}_{m}}{Δ {T}_{max}}$$

$$ρ {c}_{p} Δ {T}_{m} \frac{U}{l} = {q}_{max} {I}_{1} ( 0 , {y}_{m}^{*} )$$

we obtain:

$${I}_{1} ( 0 , {y}_{m}^{*} ) = {I}_{1} ( 0 , 0 ) \frac{Δ {T}_{m}}{Δ {T}_{max}}$$

We solve this implicit equation for yₘ* to obtain the beam width.
For a round gaussian distribution with an exponential decay penetration:

$${q}^{*} ( {x}^{*} , {y}^{*} , {z}^{*} ) = {ⅇ}^{- ( \frac{{y}^{{*}^{2}} + {z}^{{*}^{2}}}{2} )} {ⅇ}^{- {x}^{*}}$$

The standard distribution in the width is w/2, in the length is l/2, and the decay distance is xₑ.
Thus:

$${I}_{2} = {\int }_{0}^{∞} {\int }_{- ∞}^{∞} {\int }_{- ∞}^{∞} {ⅇ}^{- ( \frac{{y}^{{*}^{2}} + {z}^{{*}^{2}}}{2} )} {ⅇ}^{- {x}^{*}} ⅆ {x}^{*} ⅆ {y}^{*} ⅆ {z}^{*} = 2 π$$

$${I}_{2 =} 2 π$$

$${I}_{1} ( 0 , 0 ) = {\int }_{- ∞}^{∞} {ⅇ}^{- \frac{{z}^{{*}^{2}}}{2}} ⅆ {z}^{*} = \sqrt{2 π}$$

$${I}_{1} ( 0 , 0 ) = \sqrt{2 π}$$

$${I}_{1} ( {x}^{*} , 0 ) = {\int }_{- ∞}^{∞} {ⅇ}^{- \frac{{z}^{{*}^{2}}}{2}} {ⅇ}^{- {x}^{*}} ⅆ {z}^{*} = \sqrt{2 π} {ⅇ}^{- {x}^{*}}$$

$${I}_{1} ( {x}^{*} , 0 ) = \sqrt{2 π} {ⅇ}^{- {x}^{*}}$$

$${I}_{1} ( 0 , {y}^{*} ) = {\int }_{- ∞}^{∞} {ⅇ}^{- ( \frac{{y}^{{*}^{2}} + {z}^{{*}^{2}}}{2} )} ⅆ {z}^{*} = {ⅇ}^{- ( \frac{{y}^{{*}^{2}}}{2} )} \sqrt{2 π}$$

$${I}_{1} ( 0 , {y}^{*} ) = \sqrt{2 π} {ⅇ}^{- ( \frac{{y}^{{*}^{2}}}{2} )}$$

Heating rate:

$$ρ {c}_{p} Δ {T}_{max} \frac{U}{l} = \sqrt{\frac{π}{2}} {q}_{max}$$

Energy balance:

$$\frac{π}{2} {q}_{max} {x}_{e} wl = W$$

Penetration:

$${ⅇ}^{- {x}_{m}^{*}} = \frac{Δ {T}_{m}}{Δ {T}_{max}}$$

Weld width:

$${ⅇ}^{- \frac{{y}_{m}^{* 2}}{2}} = \frac{Δ {T}_{m}}{Δ {T}_{max}}$$

From the energy balance:

$${q}_{max} = \frac{2}{π} \frac{W}{{x}_{e} wl}$$

Replacing in the heating rate equation:

$$ρ {c}_{p} Δ {T}_{max} \frac{U}{l} = \sqrt{\frac{π}{2}} \frac{2}{π} \frac{W}{{x}_{e} wl}$$

$$U = \sqrt{\frac{2}{π}} \frac{W}{ρ {c}_{p} Δ {T}_{max} {x}_{e} w}$$

From the penetration equation:

$${x}_{m}^{*} = ln \frac{Δ {T}_{max}}{Δ {T}_{m}}$$

$${x}_{e} = \frac{{x}_{m}}{ln \frac{Δ {T}_{max}}{Δ {T}_{m}}}$$

From the weld width equation:

$${y}_{m}^{*} = \sqrt{2} \sqrt{ln \frac{Δ {T}_{max}}{Δ {T}_{m}}} ⇒ {y}_{e} = \frac{{y}_{m}}{\sqrt{2} \sqrt{ln \frac{Δ {T}_{max}}{Δ {T}_{m}}}}$$

Approximating the beam width as that where the power is 10% of the maximum:

$${q}^{*} ( 0 , \frac{w}{2 {y}_{e}} , 0 ) = 0.1 ⇒ {e}^{- \frac{1}{2} {( \frac{w}{2 {y}_{e}} )}^{2}} = 0.1 ⇒ w = 2 {y}_{e} \sqrt{2 ln 10} = 4.3 {y}_{e}$$

$$w = 3 \frac{{y}_{m}}{\sqrt{ln \frac{Δ {T}_{max}}{Δ {T}_{m}}}}$$

Replacing in the calculation for velocity

$$u = \frac{1}{\sqrt{π}} \frac{W}{ρ {c}_{p} Δ {T}_{max} {x}_{m} {y}_{m}} {ln}^{\frac{3}{2}} \frac{Δ {T}_{max}}{Δ {T}_{m}}$$

When the weld penetration is smaller than the weld width or spot length:

$$Pe = \frac{{Ux}_{m}}{α}$$

To have negligible conduction:
Pe=Peₘᵢₙ
We can use this equation to determine a lower bound for the beam power

$$w 〉 \sqrt{π} {Pe}_{min} \frac{k Δ {T}_{max} {y}_{m}}{{ln}^{3 / 2} \frac{Δ {T}_{max}}{Δ {T}_{min}}}$$

Determination of Process Parameters (Beam Width, Voltage, Current and Speed)

We need to know the material properties of the substrate(s) in order to obtain the process parameters. The materials properties are:

| | |
|---|---|
| k | :thermal conductivity |
| ρ | :density |
| cₚ | :heat capacity |
| Tₘ | :melting temperature of substrate |
| Tₘₐₓ | :maximum allowed temperature of the molten material |
| | (typically based on maximum evaporation losses the specified |
| | process can tolerate, i.e., 10-20%.) |
| $α = \frac{k}{ρ {c}_{p}}$ | :thermal diffusivity of substrate. |

Target process parameters (i.e., proposed weld geometry):

| | |
|---|---|
| xₘ | weld penetration |
| yₘ | weld bead width |

We also need to choose a minimum Peclet at the outset. Peclet numbers larger than about 1 are desirable, and Pe equal to about 3 are preferable. The higher the Peclet number, the smaller is the associated error in determination of the electron beam penetration. With the above Substrate Properties and Target Welding Parameters information quantified, we can determine the Process Parameters for the electron beam process to succeed by simply solving the following equations:
1. Beam diameter:

$$w = \frac{3 {y}_{m}}{\sqrt{ln \frac{Δ {T}_{max}}{Δ {T}_{m}}}}$$

2. Minimum beam power:

$$W 〉 \sqrt{π} {Pe}_{min} \frac{k Δ {T}_{max} {y}_{m}}{{ln}^{3 / 2} \frac{Δ {T}_{max}}{Δ {T}_{min}}}$$

3. Electron penetration:

$${x}_{e} = \frac{{x}_{m}}{ln ( \frac{Δ {T}_{max}}{Δ {T}_{m}} )}$$

4. Beam voltage V: (see Characterization of Relationship between electron beam voltage and electron penetration below.)
5. Beam current:
I=W/V
6. Beam velocity:

$$U = \frac{1}{\sqrt{π}} \frac{W}{ρ {c}_{p} Δ {T}_{max} {x}_{m} {y}_{m}} {ln}^{3 / 2} \frac{Δ {T}_{max}}{Δ {T}_{m}}$$

Relationship Between Beam Voltage and Electron Penetration

Kanaya Okayama relationship: (elastic and inelastic effects) (Kanaya K, Okayama S (1972) Penetration and Energy loss theory of electrons in solid targets. J Phys D: Appl Phys 5: 43-58.

$$R = \frac{k}{ρ} {V}^{n}$$

$$where k = 0.0276 \frac{A}{{Z}^{0.889}}$$

n=1.67

A is atomic weight in g/mole

Z is atomic number

V is voltage in kV

ρ is density in g/cm³

R is the range in which electrons lose their energy in the substrate. This method assumes it corresponds to a loss to 10% of their original value.

For an exponential decay:

$${ⅇ}^{- \frac{R}{{x}_{e}}} = 0.1$$

$${x}_{e} = R / ln 10$$

$${x}_{e} = R / 2.3 \\ V = {( \frac{ρ}{k} 2.3 {x}_{e} )}^{\frac{1}{n}}$$

FIGS. 3A and 3B show the weld depth achieved using the foregoing calculations and process parameters developed by the present method. Weld penetration is measured from the uppermost surface of the material being treated either as a single element (3A) or as a part of layered elements (3B). The depth of weld approximates the penetration of the electrons during the process.

### EXAMPLE 1

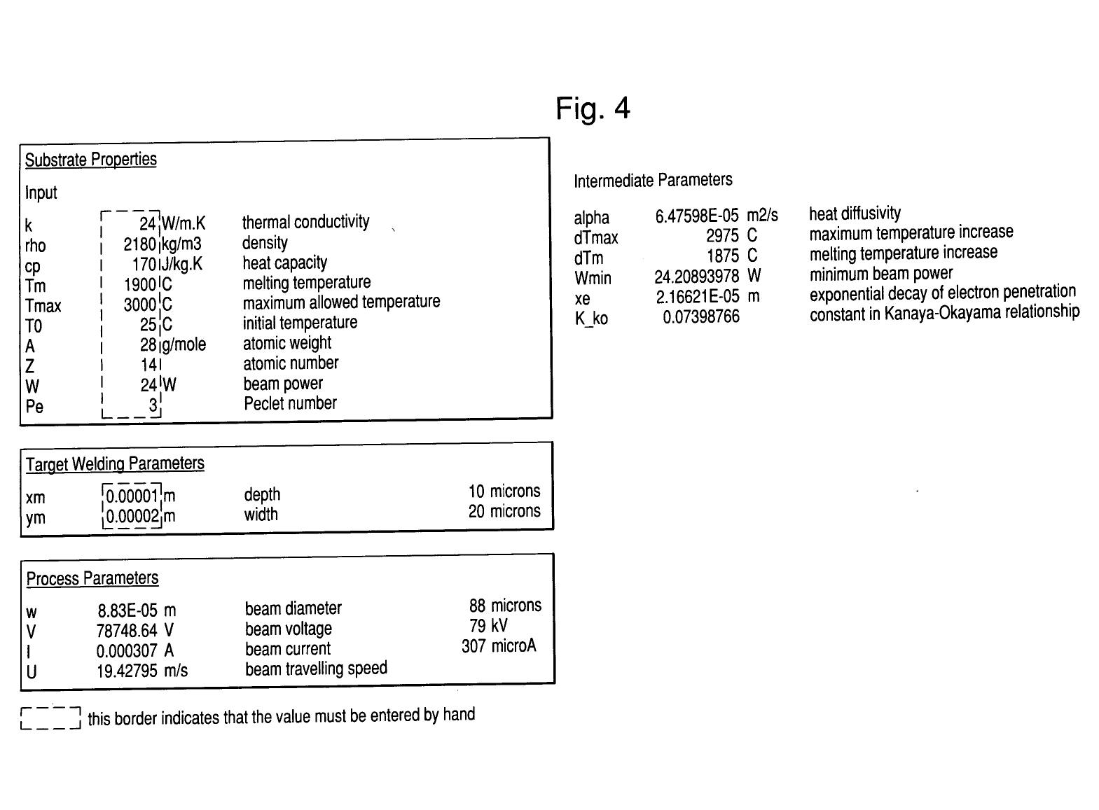

FIG. 4 shows, in spreadsheet form, the results of the foregoing calculations based on the input of Substrate properties indicated. Along with Substrate properties, a Peclet number of 3 is chosen, and a specified weld geometry (10 microns deep and 20 microns wide) is set. Solving the equations yields Process Parameters of beam diameter w, beam voltage V, beam current I, and beam traveling speed U.

For dissimilar materials, i.e., the respective layers being welded have differing characteristics, the following guidelines should be followed when inputing information into the above equations to determine process parameters.

Thermal conductivity should be input according to the higher value from among respective layers to assure melting of all layers. Likewise, density should be controlled by the highest value to assure sufficient electron beam voltage for any of the materials. Heat capacity should be determined by the layer opposite to the site of electron beam penetration, i.e., the substrate beneath a cover positioned thereon. Melting temperature should be controlled by the highest melting temperature of the assembled layer(s). In contrast, the maximum allowed temperature should be controlled by the maximum allowed temperature of the uppermost of the layered materials. The reason for the maximum temperature control in the upper layer is that this factor creates the limit on evaporative losses of the materials where it is most likely to occur, i.e., in the uppermost layer being subject to the electron beam exposure. Evaporative losses should be limited to 10-20% of the total weld penetration and, in any event, should be somewhat less than the thickness of the uppermost layer (cover) in the treated layer(s). If this upper limit on evaporative losses is not observed, the uppermost layer would cease to be welded to whatever layers existed beneath. Atomic weight should be selected on the basis of the lowest from among the atomics weights of the assembled layer(s), whereas Atomic number should be selected on the basis of the highest atomic number of the assembled layer(s).

According to the present method, some assumptions apply in these calculations to determine process parameters. First, and as already noted, a fast moving volumetric heat source is assumed. Conduction heat transfer is considered to be negligible owing to the timescale each point will be exposed to the electron beam source during its relatively rapid movement across the treated materials. Rather, the heat in the treated materials is generated by electron penetration and creates a volume of heat input, as shown in cross section in FIGS. 3A and 3B, according to that depth of penetration. This assumes that there is significant generation of heat in the bulk of the weld due to the electron penetration under the surface. The depth of the weld and the depth of electron penetration are assumed to have similar orders of magnitude. This is in contrast with the standard use of electron beams in welding in which the heat carried by the electrons is assumed to be at the surface.

The heat of phase change, i.e. solid to liquid, of the respective materials being treated has also been neglected owing to its minor effect on calculating the overall process parameters. Lastly, it is assumed that the weld pool does not deepen to any appreciable degree following passage of the electron beam exposure of the weld site. Owing to the circumstance that the source of heat, i.e., the electron beam penetration, has already passed the weld site along with the assumed relative lack of conduction within the treated materials, the weld depth is only associated with the depth of penetration of the electron beam and, hence, the extent of the molten material does not increase following electron beam exposure. This is valid for cases where the maximum temperature is approximately less than twice the melting temperature increase.

### EXAMPLE 2

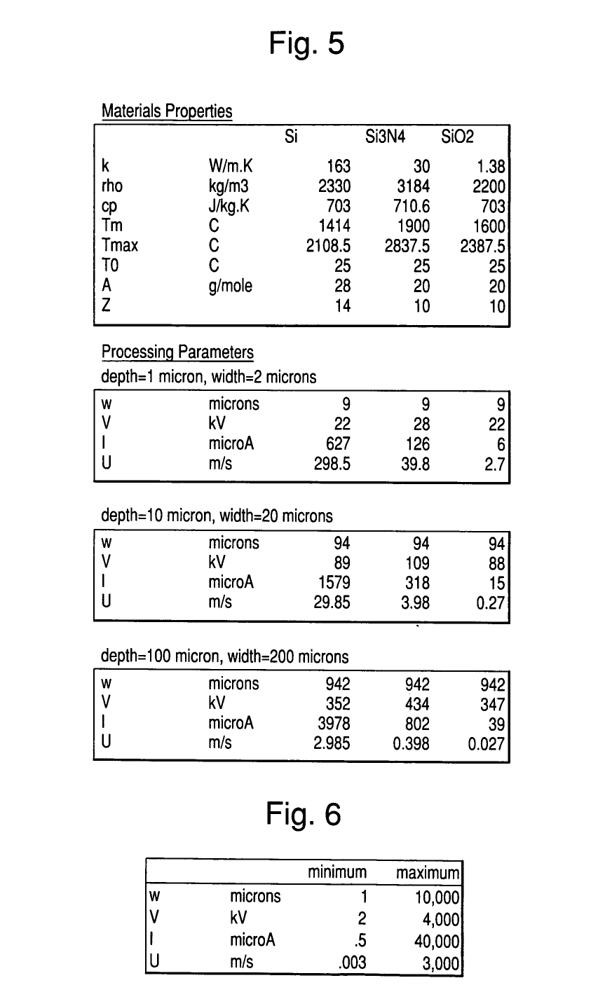

FIG. 5 shows spreadsheet calculations for process parameters of the current method for each of Silicon, Silicon Nitride and Silica Glass. The process parameter calculations were performed for three preset weld geometries of 1, 10, and 100 microns penetration (depth) and a width twice the depth. The maximum allowed temperature increase was 150% of the melting temperature increase in each case. The maximum beam diameter calculated was of the order of 400 kV, and the minimum was 22 kV. The maximum current was 4000 microamperes, while the minimum was 6 microamperes. The maximum beam velocity was on the order of 300 n/s and a minimum of 0.03 m/s. The presumed limits of the calculable process parameters of the present method are shown in FIG. 6.

While various preferred embodiments of the subject invention have been disclosed, it is understood that the invention may be made to include various modifications without departing from the spirit and scope of the invention as set forth in the following claims.

We claim:

1. A method of welding using an electron beam energy source, comprising the steps of:
positioning at least two materials to be welded adjacent one another;
creating a weld pool in said materials having a depth corresponding to a predetermined penetration of said electron beam into said materials;
translating said weld pool along a predetermined desired path of welding at a predetermined velocity, thereby welding a portion of said materials one to the other.

2. A method of welding using an electron beam energy source as in claim 1, wherein:
said weld pool is created using volumetric heating.

3. A method as in claim 1, wherein:
said beam velocity is selected between 0.003 and 3000 meters per second.

4. A method as in claim 1, wherein:
said beam width is selected between 1 and 10,000 micrometers.

5. A method as in claim 1, wherein:
said beam current is selected between approximately 0.5 and 40,000 microamperes.

6. A method as in claim 1, wherein:
said beam voltage is selected between 2 and 4,000 kV.

7. A method as in claim 1, wherein:
said depth of said weld pool is approximately equal to the heat penetration of said electron beam.

8. A method of welding using an electron beam source, comprising the steps of:
selecting at least two materials to be welded;
adjusting said electron beam energy source operational parameters of beam velocity, width, current, and voltage in accordance with said respective materials heat response characteristics to achieve a Peclet number in excess of 1 for proposed welding between said respective materials so as to obtain a desired degree of weld between said materials without compromising said materials through excessive ablation or evaporation;
placing said materials adjacent one another;
applying and guiding said electron beam source in accordance with said predetermined electron beam energy source operational parameters along a chosen seam between said materials;
creating a weld pool of melted materials through volumetric heating by said electron beam energy source having a depth approximately equal to the penetration depth of an electron beam of said electron beam energy source into said materials;
welding a portion of said materials one to the other.

9. A method as in claim 8, wherein
said Peclet number is less than about 10.

10. A method as in claim 8:
wherein said Peclet number is about 3.

11. A method of welding a cover element to a substrate to encapsulate a micro device using an electron beam energy source, comprising the steps of:
selecting a cover element material and substrate material appropriate to the performance parameters of said micro device;
adjusting said electron beam energy source operational parameters of traveling velocity, spot size, welding current, and voltage in accordance with said respective cover and substrate materials heat response characteristics to achieve a Peclet number in excess of about 1 for welding between said respective materials so as to obtain a desired degree of weld between said materials without compromising said materials;
placing said cover element and substrate so as to encapsulate said micro device;
applying and guiding said electron beam source in accordance with said predetermined electron beam energy source operational parameters along a chosen seam between said cover and substrate so as to weld said cover to said substrate.

12. A method as in claim 11, wherein:
said Peclect number is less than about 10.

13. A method as in claim 11, wherein:
said Peclet number is about 3.

14. A method as in claim 11, wherein:
said electron beam traveling velocity is selected between 0.05 and 300 meters per second.

15. A method as in claim 11, wherein:
said electron beam spot size is selected between 1 and 1000 micrometers.

16. A method as in claim 11, wherein:
said electron beam current is selected between approximately 0.5 and 5000 microamps.

17. A method as in claim 11, wherein:
said electron beam voltage is selected between 2 and 400 kV.

18. An electron beam welding device, comprising:
an electron beam energy source having a beam velocity which is between 0.003 and 3,000 meters per second, a beam width selected between 1 and 10,000 micrometers, a beam current between approximately 0.5 and 40,000 microamps, and a beam voltage selected between about 2 and 4000 kV; and
a controller for moving said electron beam energy source.

19. A method as in claim 18, wherein:
said traveling velocity is between about 0.05 and 300 meters per second.

20. A method as in claim 18, wherein:
said electron beam spot size is between about 1 and 1000 micrometers.

21. A method as in claim 18, wherein:
said beam current is between 0.5 and 5000 microamps.

22. A method as in claim 18, wherein:
said electron beam voltage is between about 2 and 400 kV.
